(19) United States
(12) Patent Application Publication
(10) Pub. No.: US 2003/0077014 A1
(43) Pub. Date: Apr. 24, 2003

(54) Device with a bearing

(76) Inventors: Jans-Juergen Oberle, Rastatt (DE); Andreas Lienig, Buehl (DE); Mario Huesges, Buehlertal (DE)

Correspondence Address: Striker Striker & Stenby, 103 East Neck Road, Huntington, NY, 11743, US

(21) Appl. No.: 10/181,579

(22) PCT Filed: Nov. 23, 2001
(86) PCT No.: PCT/DE01/04385

(30) Foreign Application Priority Data
Nov. 25, 2000 (DE) 100 58 591.4

(51) Int. Cl. F16C 35/00

(52) U.S. Cl. 384/428

(57) ABSTRACT

According to the related art, a bearing is secured in an apparatus by means of an additional attachment means.

In the case of an apparatus (1), according to the invention, having at least one bearing (8), the attachment means (14) are arranged on a housing part (5, 7) and do not require an additional production step to be installed.

### BACKGROUND OF THE INVENTION

The invention is based on an apparatus having a bearing according to the general description of claim 1.

A drive assembly is made known in DE 197 27 120 A1 in which a bearing is secured in a transmission housing by means of a holding bracket. This additional holding bracket requires an additional production step to be installed. It is thereby possible that the part will be placed incorrectly or left out during installation.

### ADVANTAGES OF THE INVENTION

In contrast, the apparatus according to the invention having the characterizing features of claim 1 has the advantage that a bearing is secured in a housing part in a simple manner.

Advantageous further developments and improvements to the apparatus named in claim 1 are possible by means of the measures listed in the dependent claims.

The bearing can be secured in the first housing part in advantageous fashion by means of single-sided or two-sided pressing.

It is further advantageous when the bearing is secured in the first housing part by means of one-sided or two-sided springiness.

### SUMMARY OF THE DRAWINGS

Exemplary embodiments of the invention are shown in the drawings in simplified form and are described in greater detail in the subsequent description.

FIG. 1 shows an apparatus according to the invention.

FIGS. 2a, b show an attachment by means of pressing a bearing in a first housing part,

FIGS. 3a, b shows a springy securing of a bearing in a first housing part.

### DESCRIPTION OF THE PREFERRED EMBODIMENTS

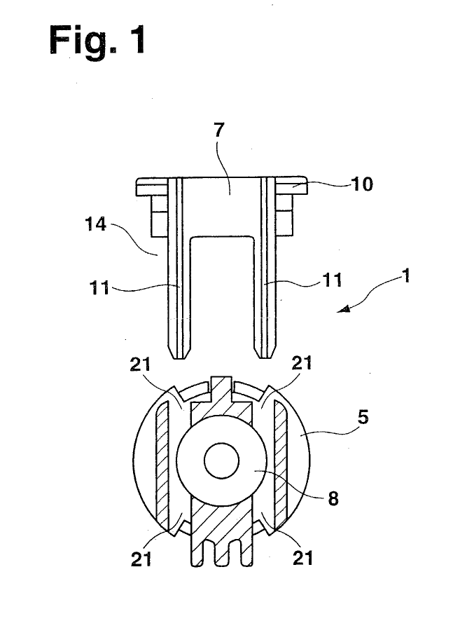

FIG. 1 shows an apparatus 1 according to the invention. Such an apparatus 1 can be a drive assembly, for example, as made known, for example, in DE 197 27 120 A1. Said publication is expressly intended to be part of this disclosure.

The apparatus 1 is composed of, among other things, at least two housing parts. In this exemplary embodiment there is a first housing part 5 and a second housing part 7 that is a cover of a transmission unit of the drive assembly, for example.

A bearing 8 is arranged in the first housing part 5, in which a not further shown rotor shaft of an electrical machine or a drive assembly is to be supported. The bearing 8 can be a rolling bearing or a plain bearing. The bearing 8 is not secured in the first housing part 5 in the direction perpendicular to the plane of the drawing. The bearing 8 is not secured in the apparatus 1 until the second housing part 7—which has a U-shape with a bottom part 10 and two projections 11—is installed in the direction of the plane of the drawing.

The projections 11 therefore form an attachment means 14 for the bearing 8. The projections 11 are developed as straight strips, for example, and engage in guide rails or recesses 21 of the first housing part 5 in such a fashion that they press the bearing 8 into the first housing part 5 perpendicularly to the plane of the drawing.

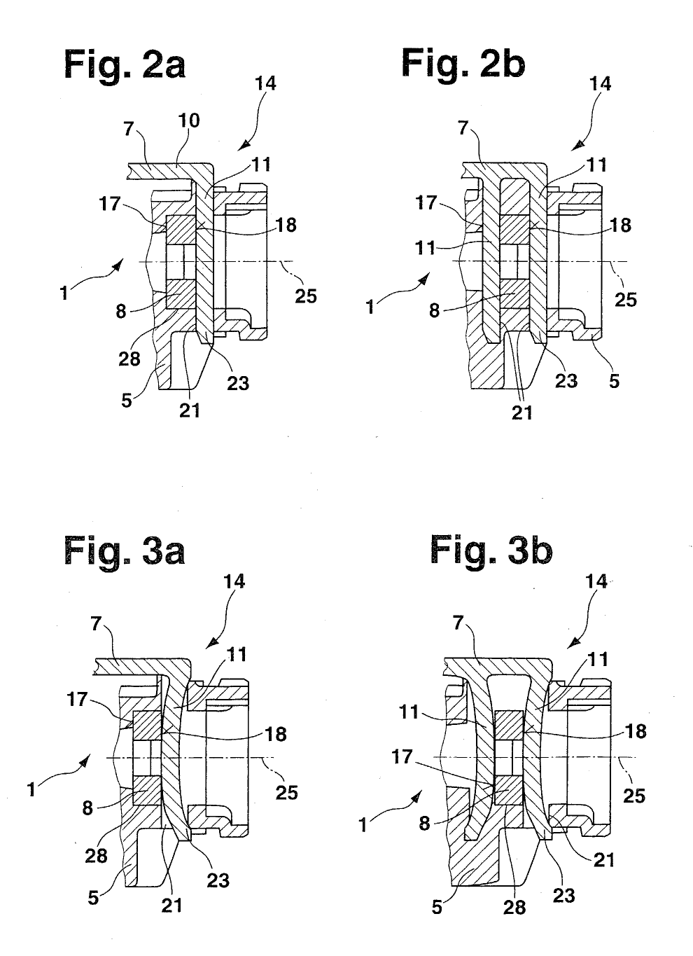

FIG. 2a shows how the bearing 8 is pressed on the first housing part 5 by means of the projections 11 when the second housing part 7 is connected with the first housing part. The bearing 8 has a first end face 17 and a second end face 18. The bearing 8 rests—with the first end face 17—in the first housing part 5, e.g., in a cavity 28. The bearing 8 is thereby installed in the first housing 5 along an axial axis 25.

The at least one projection 11 bears against the second end face 18 and results in a single-sided press fit of the bearing 8 by means of the attachment means 14. An exposed end 23 of the projection 11 thereby engages, for example, in a recess 21 of the first housing part 5.

FIG. 2b shows that the bearing 8, with its end faces 17, 18, bears only on the projections 11 and not on the first housing part 5. The attachment element 14 is therefore formed, for example, by means of four projections 11, between which the bearing 8 is arranged and, as a result, is pressed in on two sides, i.e., the bearing 8 is secured in the housing part 5 on each end face 17, 18 by means of pressing by the attachment means 14.

The bearing 8 can thereby be installed longitudinally or perpendicularly to the axial axis 25.

In FIGS. 3a, b, the bearing 8 is secured not by means of a rigid press fit, but by means of a springy effect of the projections 11. This can take place—in a fashion analogous to FIGS. 2a, b—by means of single-sided or two-sided springy securing of the bearing 8.

The projections 11 are thereby bent and can be elastically deformed in such a fashion that they exert a spring force along the axial axis 25.

What is claimed is:

1. An apparatus having at least one bearing, in particular a drive assembly that is composed of at least two housing parts,
in which the at least one bearing for a rotor shaft is arranged,
whereby the bearing rests in a first housing part and is secured in the first housing part by means of an attachment means,
wherein
the attachment means (14) are arranged on a second housing part (7) and secure the bearing (8) when the housing parts (5, 7) are assembled.

2. The apparatus according to claim 1,
wherein
the bearing (8) has two end faces (17, 18), and the bearing (8) is secured in the first housing part (5) on one of the end faces (17, 18) by means of single-sided pressing by the attachment means (14).

3. The apparatus according to claim 1,
wherein
the bearing (8) has two end faces (17, 18), and wherein the bearing (8) is secured in the first housing part (5) on each end face (17, 18) by means of pressing by the attachment means (14).

4. The apparatus according to claim 1 or 2,
wherein
the bearing (8) has two end faces (17, 18), and
wherein the bearing (8) is secured in the first housing part (5) on one of the end faces (17, 18) by means of the attachment means (14) having a springy design.

5. The apparatus according to claim 1,
wherein
the bearing (8) has two end faces (17, 18), and
wherein the bearing (8) is secured in the first housing part (5) on each end face (17, 18) by means of the attachment means (14) having a springy design.

6. The apparatus according to one or more of the preceding claims,
wherein
the second housing part (7) has at least two projections (11) that form a part of the attachment means (14).

7. The apparatus according to claim 2 or 3,
wherein
the at least one projection (11) is a straight bar.

8. The apparatus according to claim 4 or 5,
wherein
the at least one projection (11) is a bent, springy bar.
